(19) United States
(12) Patent Application Publication
(10) Pub. No.: US 2008/0041302 A1
(43) Pub. Date: Feb. 21, 2008

(54) Paint application element for connection to a handle

(76) Inventor: Rudolphus Johannes Adrianus Maria Cornelissen, Schaijk (NL)

Correspondence Address: LAW OFFICES OF ERIC KARICH, 2807 ST. MARK DR., MANSFIELD, TX, 76063, US

(21) Appl. No.: 11/901,708

(22) Filed: Sep. 18, 2007

(30) Foreign Application Priority Data
May 2, 2006 (NL) 1031732
Mar. 30, 2007 (NL) 2000565
May 2, 2007 (NL) PCT/NL2007/050194

(51) Int. Cl. B05C 11/04

(52) U.S. Cl. 118/56; 15/210.1

(57) ABSTRACT

A paint application element for connection to a handle has a flexible carrier, and a smoothing device present on it. The smoothing device comprises a smoothing layer, and a liquid absorbing layer that is present between the smoothing layer and the carrier. The carrier is formed by a pliable strip and is provided with a free end that during the paint application presses the smoothing device against the surface to be painted. The smoothing device is stretched over the free end of the carrier, so that the liquid absorbing layer is pressed together by the free end and the smoothing layer there is present at a shorter distance from the carrier than by adjacent parts of the smoothing device.

### BACKGROUND OF THE INVENTION

1. Field of the Invention

The invention relates to a paint application element for connection to a handle, which paint application element comprises a flexible carrier and a smoothing device present on it. A paint application element is defined as an element for the application of a layer of paint on an object.

2. Description of Related Art

A paint applier provided with a paint application element is known from the American patent U.S. Pat. No. 2,962,746. In this the carrier is formed by a flexible sponge element and the smoothing device by a sponge layer for holding and spreading paint. The carrier and the smoothing device are here clamped between the two halves of the handle. Paint is taken up by dipping the smoothing device in paint, which can then be spread on a surface.

With respect to paint brushes, the well-known paint applier has the advantage that it can apply a thinner layer of paint to an object and so has to be dipped in the paint less often. Moreover, no streaks are drawn in the paint, due to the absence of hairs. There is no problem with loose hairs with the well-known paint applier, which can be disturbingly left behind in the newly applied paint layer. An important advantage is also that the paint applier can be cleaned more easily than a paint brush or even does not have to be cleaned at all by throwing away the smoothing device after use and replacing it with a new smoothing device.

The form and material properties of the holder are chosen to give the same flexibility as a brush. In this way the well-known paint applier can be moved in the same way as a brush during use so that working with the well-known paint applier needs no practice on the part of the user.

### SUMMARY OF THE INVENTION

An objective of the invention is to provide a paint application element of the sort described in the preamble with which painting can be done better. For this purpose the paint application element according to the invention is characterised in that the smoothing device comprises a smoothing layer, and a liquid absorbing layer, which is present between the smoothing layer and the carrier, which carrier is formed by a pliable strip and is provided with a free end that presses the smoothing device against the surface to be painted during application, in which the smoothing device is stretched over the free end of the carrier so that the liquid absorbing layer by the free end is pressed together and the smoothing layer is present there at a shorter distance from the carrier than by adjacent parts of the smoothing device. With this construction of the paint application element the element more or less scrapes over the surface to be painted, so that a uniformly thin layer of paint is applied.

An embodiment of the paint application element according to the invention is characterised in that the free end of the strip is slightly bent and rounded. This means that when the paint application element is lifted off the surface to be painted the edges of the carrier first come free and then the middle section so that the side edges of the applied strip of paint are sharper than they would be if the free end of the strip were straight.

A further embodiment of the paint application element according to the invention is characterised in that the strip is fastened by a further end to a connecting element, which is present opposite the free end, for connection to a roller holder of a paint roller, which roller holder comprises a handle, as well as a section connected to the handle, which is provided on the free end with an axle for a paint roller, in which the connecting element comprises first connecting devices for connection to the axle of the roller holder, and second connecting devices for connection to the section of the roller holder between the axle and the handle. As roller holders of paint rollers are very often in the possession of users of paint accessories, these users only need to buy a relatively inexpensive paint application element that is not provided with a handle. Moreover they do not have to buy a separate handle and they can use the roller holders already in their possession for this purpose.

Preferably the first connecting devices comprise a hollow cylinder, into which the axle is inserted, and the second connecting devices comprise at least one omega-shaped spring clip that is clamped on the part of the roller holder present between the axle and the handle.

Note that in the embodiments described here the connecting element can also be used independently of the shape of the carrier, so that the option is expressly upheld to protect a paint application element, provided with a connecting element for connection to a roller holder of a paint roller, separately, that is independent of the shape of the carrier.

A still further embodiment of the paint application element according to the invention is characterised in that the smoothing layer is comprised of a low-polar material. This material can be easily spread over surfaces to be painted and provides a good paint result. Preferably the material is made at least partly of polyester.

The carrier is preferably provided with holes. The paint taken up that is present on one side of the carrier, which at that moment is directed towards the surface to be painted, can flow through these holes easily and quickly to the other side of the carrier.

### BRIEF DESCRIPTION OF THE DRAWINGS

The accompanying drawings illustrate the present invention. In such drawings:

FIG. 1 shows an embodiment of the paint application element according to the invention fixed on a roller holder of a paint roller in front elevation;

FIG. 2 shows the paint application element shown in FIG. 1 on a roller holder in side elevation, with the smoothing device in cross-section; and

FIG. 3 shows the paint application element alone in perspective.

### DETAILED DESCRIPTION OF THE INVENTION

The above-described drawing figures illustrate the invention, a paint application element for connection to a handle.

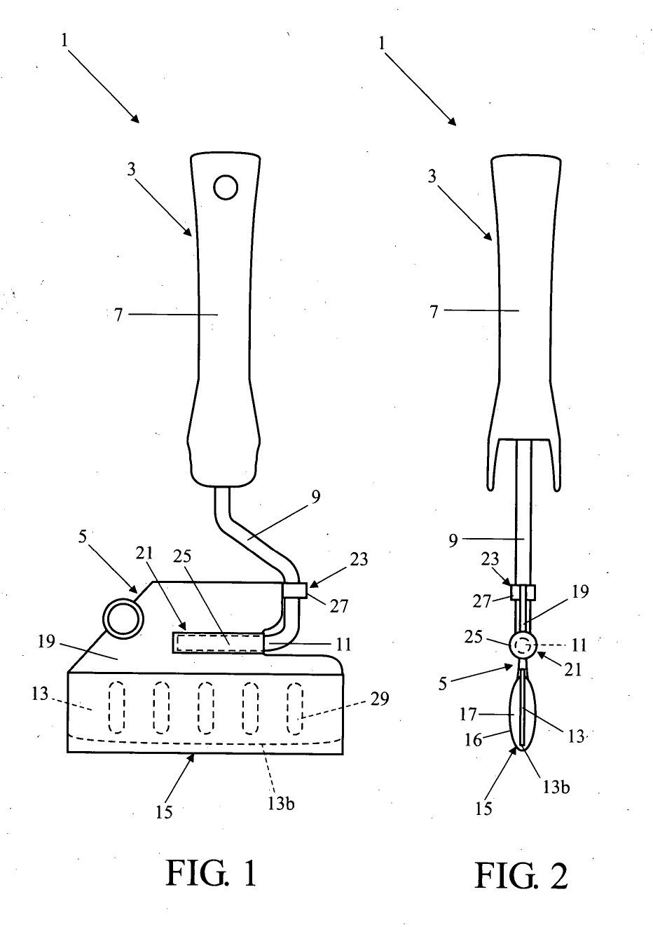

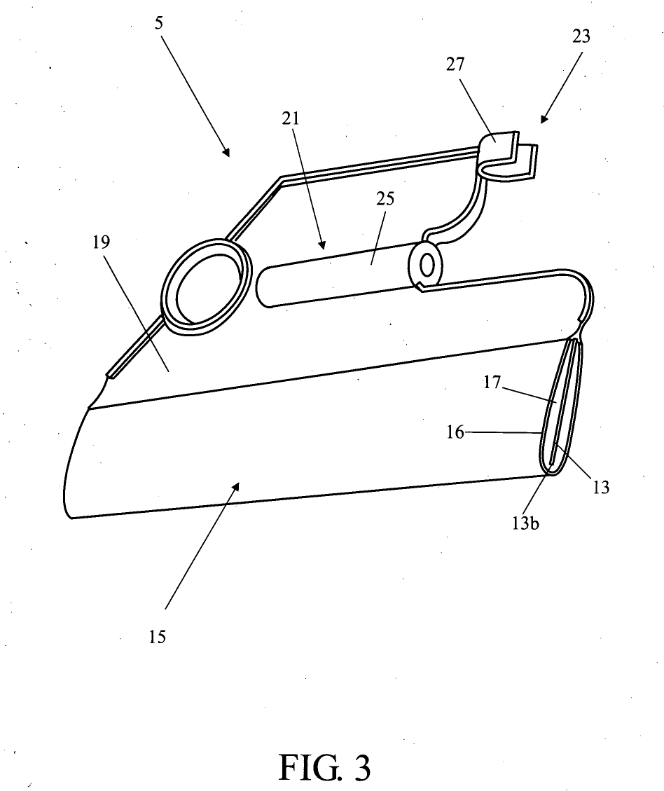

FIGS. 1 and 2 show a paint applier provided with an embodiment of the paint application element according to the invention in front and side elevation respectively and FIG. 3 shows the paint application element alone. The paint applier 1 is composed of a well-known roller holder 3 of a paint roller and a paint application element 5 according to the invention connected to it.

The roller holder 3 consists of a handle 7 and a part 9 connected to the handle, which is provided on the free end with an axle 11 for a paint roller. The part 9 is formed by a bent rod.

The paint application element 5 has a flexible carrier 13 on which a smoothing device 15 is present. The smoothing device is built up of a smoothing layer 16 and a liquid absorbing layer 17, which is present between the smoothing layer and the carrier, see FIG. 2. More paint can be taken up by the liquid absorbing layer 17 when it is dipped in paint, and a larger area can therefore be coated with one dip.

The carrier 13 is formed by a pliable strip and is provided with a free end 13b, which during spreading presses the smoothing device against the surface to be painted. The smoothing device 15 is stretched over the free end 13b of the carrier. The liquid absorbing layer 17 is pressed together by this at the free end 13b, so that the smoothing layer 15 by the free end 13b is present at a shorter distance from the carrier 13 than by the adjacent parts of the smoothing device.

The free end of the carrier 13 is slightly bent, see FIG. 1. When the paint application element 5 is taken off the surface to be painted, this causes first the edges and then the middle section of the carrier 13 to become free, which gives a better paint result.

The paint application element 5 also has a connecting element 19 for connection of the paint application element to a roller holder 3 of a paint roller. The connecting element has first connecting devices 21, for connection to the axle 11 of the roller holder, and second connecting devices 23, for connection to the part 9 of the roller holder between the axle and the handle.

The first connecting devices 21 are formed by a hollow cylinder 25, into which the axle 11 is inserted. The second connecting devices 23 are formed by an omega-shaped spring clip 27, which is clamped onto the part 9.

The carrier 13 is provided with holes 29. This means the taken-up paint, which is present on one side of the carrier, can flow easily and quickly to the other side of the carrier.

The smoothing layer 15 is a low-polar polyester material, which consists of about 80% polyester and 20% cotton. The paint-absorbing layer 17 is formed by a sponge layer, which is glued onto the smoothing layer.

Although in the above the invention is explained on the basis of the drawings, it should be noted that the invention is in no way limited to the embodiments shown in the drawings. The invention also extends to all embodiments deviating from the embodiments shown in the drawings within the context defined by the claims.

What is claimed is:

1. Paint application element for connection to a handle, the paint application element comprising:
a flexible carrier, and a smoothing device present on it, characterised in that the smoothing device comprises a smoothing layer, and a liquid absorbing layer that is present between the smoothing layer and the carrier, which carrier is formed by a pliable strip and is provided with a free end that during the paint application presses the smoothing device against the surface to be painted, in which the smoothing device is stretched over the free end of the carrier, so that the liquid absorbing layer is pressed together by the free end and the smoothing layer there is present at a shorter distance from the carrier than by adjacent parts of the smoothing device.

2. Paint application element according to claim 1, characterised in that the free end of the strip is slightly bent and rounded.

3. Paint application element according to claim 1, characterised in that the strip is fastened by a further end present opposite the free end to a connecting element, for connection to a roller holder of a paint roller, which roller holder comprises a handle, and a part connected to the handle, which on the free end is provided with an axle for a paint roller, in which the connecting element first comprises connecting devices for connection to the axle of the roller holder, and second connecting devices for connection to the part of the roller holder between the axle and the handle.

4. Paint application element according to claim 3, characterised in that the first connecting devices comprise a hollow cylinder, into which the axle is inserted, and the second connecting devices comprise at least one omega-shaped spring clip, which is clamped on the part of the roller holder present between the axle and the handle.

5. Paint application element according to claim 1, characterised in that the smoothing layer comprises a low-polar material.

6. Paint application element according to claim 5, characterised in that the material is at least partly made of polyester.

7. Paint application element according to claim 1, characterised in that the carrier is provided with holes.

8. Paint application element for connection to a handle, the paint application element comprising:
a flexible carrier having a pliable strip, the pliable strip having a free end;
a smoothing device stretched over the free end of the flexible carrier, the smoothing device having a smoothing layer, and a liquid absorbing layer that is present between the smoothing layer and the carrier; and
wherein when the smoothing device is pressed against the surface to be painted, the liquid absorbing layer is compressed between the free end and the smoothing layer.

9. Paint application element according to claim 8, wherein the carrier includes holes.

10. A paint applier comprising:
a paint application element comprising:
a flexible carrier having a pliable strip, the pliable strip having a free end; and
a smoothing device stretched over the free end of the flexible carrier, the smoothing device having a smoothing layer, and a liquid absorbing layer that is present between the smoothing layer and the carrier; and
a handle attached to the paint application element with a rod.
